(19) United States
(12) Patent Application Publication
(10) Pub. No.: US 2016/0063629 A1
(43) Pub. Date: Mar. 3, 2016

(54) Processing Decomposing Financial Instruments

(71) Applicant: CHICAGO MERCANTILE EXCHANGE INC., Chicago, IL (US)

(72) Inventors: John Nyhoff, Darien, IL (US); John Labuszewski, Westmont, IL (US); John Kerpel, Chicago, IL (US); Richard Co, Chicago, IL (US); Lori Aldinger, Naperville, IL (US)

(21) Appl. No.: 14/471,963

(22) Filed: Aug. 28, 2014

(51) Int. Cl. G06Q 40/06

(52) U.S. Cl. CPC G06Q 40/06

(57) ABSTRACT

Systems and methods are provided for processing financial instruments. An original financial instrument may be a futures contract that is a combination of financial instruments or is based on a combination of financial instruments. The original financial instrument includes a provision identifying one or more decomposition events. When a decomposition event occurs, a futures contract composition computer or other device decomposes the original financial instrument into two or more financial instruments.

### FIELD OF THE INVENTION

Aspects of the invention relate to processing of financial instruments. More particularly, aspects of the invention relate to processing financial instruments that decompose into other financial instruments upon occurrence of a decomposition event.

### BACKGROUND

Traders of financial instruments often trade combinations of financial instruments or instruments based on combinations of financial instruments. Financial instruments include equity instruments, bonds, debt instruments, option contracts and futures contracts. Combinations of financial instruments or instruments based on combinations of financial instruments include baskets, indexes, spreads, etc. Baskets may include exempt securities, non-exempt securities, other financial obligations and commodities. One example of a financial instrument is a credit default swap. A credit default swap contract involves the transfer of the credit risk. The buyer of a credit default swap receives credit protection, whereas the seller of the credit default swap guarantees the credit worthiness of the debt security. In doing so, the risk of default is transferred from the buyer of the credit default swap to the seller of the swap. For example, the buyer of a credit default swap will be entitled to the par value of the contract by the seller of the swap, should the third party default on payments.

It can be difficult to determine a final settlement price of some financial instruments if certain events occur. For example, the value of a financial instrument may be based on a value of an index of credit default swaps. A credit event, such as a bankruptcy, can occur which can result in the timing and the method used to determine a final settlement price of an impacted index or basket constituent deviating from the timing or method used to determine the final settlement price of the original index.

Accordingly, there is a need in the art for improved systems and methods for processing combinations of financial instruments or instruments based on combinations of financial instruments when value impacting events occur.

### SUMMARY OF THE INVENTION

Aspects of the invention overcome at least some of the problems and limitations of the prior art by providing systems and methods for decomposing financial instruments when certain events occur. An original financial instrument may be a futures contract that is based upon an index of credit default swaps. The credit default swap index may be viewed as a basket of single name credit default swaps. When a decomposition event, such as a bankruptcy, occurs, the original financial instrument may be decomposed into two financial instruments. The first financial instrument may be based on the single name credit default swap related to the bankruptcy. The second financial instrument may include an index that is no longer includes the single name credit default swap related to the bankruptcy. The second financial instrument may settle in a manner and at a time that is the same as the original financial instrument. The first financial instrument may settle at a different time and use a different procedure.

In other embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention.

FIG. 2 illustrates a method of processing financial instruments, in accordance with an embodiment of the invention.

FIG. 3 shows a system that may be used to process futures contracts in accordance with embodiments of the invention.

### DETAILED DESCRIPTION

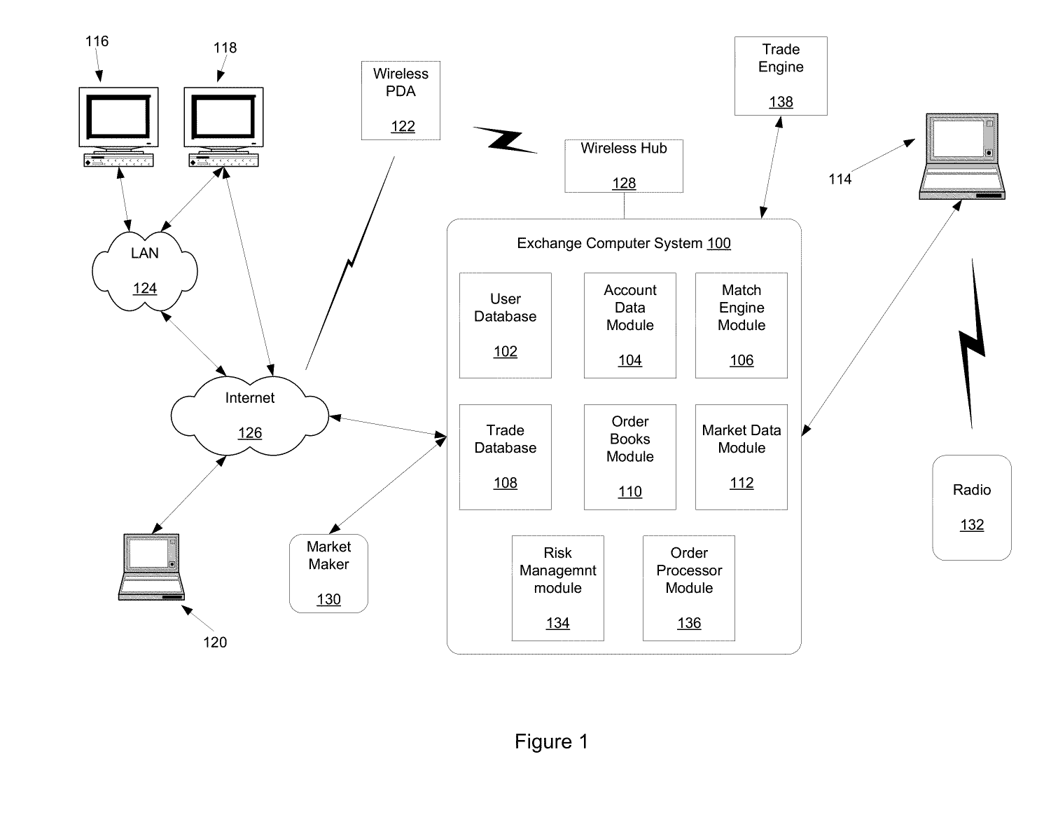

Aspects of the present invention are preferably implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a Ti line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

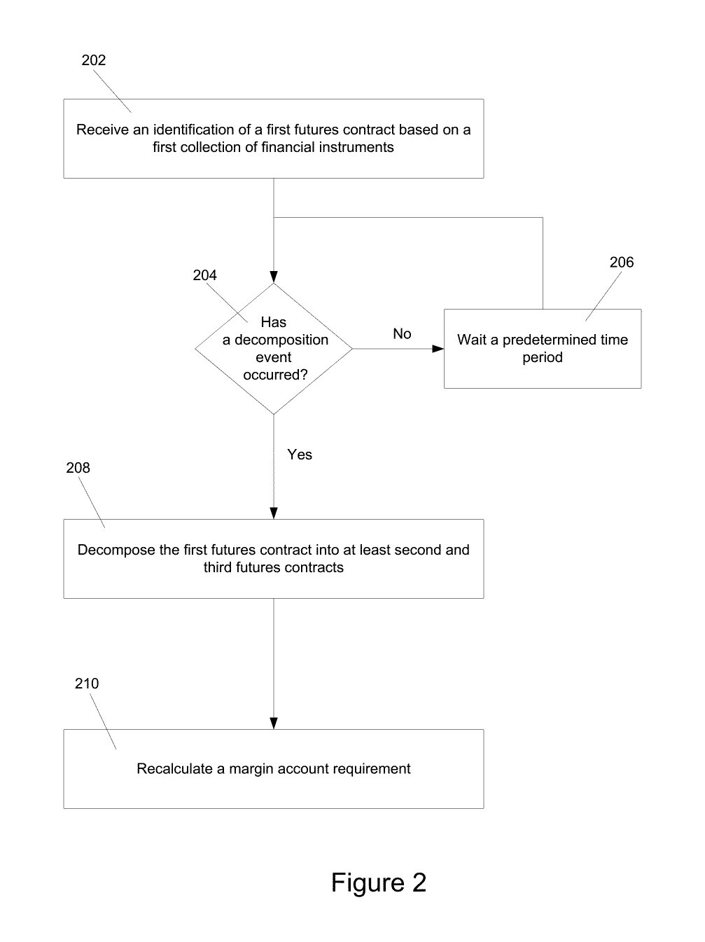

FIG. 2 illustrates a method of processing financial instruments, in accordance with an embodiment of the invention. In step 202, an identification of a first futures contract based on a first collection of financial instruments is received. In the example shown, the financial instrument comprises a futures contract that is based on a collection of financial instruments. The futures contract may be based on an index of credit default swaps. Credit default swaps may be associated with one or more commercial entities and/or one or more sovereign debt obligations. In alternative embodiments, combinations of financial instruments or instruments based on combinations of financial instruments such as equity instruments, bonds, debt instruments, option contracts and futures contracts, baskets, indexes, spreads, etc.

The identification may be received at a futures contract composition computer or other device that includes a processor. The identification may include terms of the financial instrument, such as a settlement date and a settlement procedure. In some embodiments financial instruments are cash settled and in other embodiments that are settled by physical delivery.

Next, in step 204 it is determined if a decomposition event has occurred. A decomposition event may include a bankruptcy, a default on payments, a value of a financial instrument that is part of an index of financial instruments exceeding a predetermined percentage of a value of the index of financial instruments, or any other event agreed upon by the parties.

When no decomposition event has occurred, in step 206 the process waits a predetermined time period before returning to step 204 and once again determining whether a decomposition event has occurred. The predetermined time period may be one day, one hour or some other time period. When a decomposition event has occurred, in step 208, the first futures contract is decomposed into at least second and third futures contracts. The second futures contract may include or be based on all of the original financial instruments not associated with the decomposition event. The third futures contract may only include or be based on the financial instrument associated with the decomposition event. In some embodiments of the invention the third futures contract may be replaced with another financial instrument. The financial instrument may take the form of a commodity futures contract, a security futures product, an over-the-counter (OTC) forward or swap contract, an option on futures contract, a security option contract, or (6) other types of financial instruments. The regulatory characterization of the new financial instrument may be the same as, or different than, the regulatory characterization of the original first futures contract.

The decomposition event may require a change in a settlement procedure or time. For example, when a credit default swap is associated with a commercial entity, such as a corporation, that initiates bankruptcy, the value of the credit default swap may be determined at an auction, which may occur before or after the original futures contract final settlement date. Decomposing the original financial instrument into two financial instruments allows for isolating the instrument that now has a different final settlement procedure or time from the remaining financial instruments.

In one example, a primary financial instrument is based upon the value of an index of credit default swaps consisting of one-hundred corporations. A decomposition event may be defined as the default or bankruptcy of one of those corporations. Upon the occurrence of such default or bankruptcy, the primary financial instrument may continue to be valued based upon an index of credit default swaps referencing the remaining ninety-nine corporate entities. A secondary contract is based upon the value of the decomposed corporate entity that incurred a default or bankruptcy.

In another example, a primary contract is cash settled based upon an index of individual equity securities. A decomposition event may be defined as a situation where the value of an individual equity advances such that its weighting in the index exceeds a pre-specified level such as 30%. Upon the occurrence of such an event, the primary contract may continue to be valued based upon an index of individual equity securities as originally specified less the decomposed equity security. A secondary contract is based upon the value of the decomposed equity security and is settled through physical delivery or cash settlement as pre-specified in the contract specifications.

Altering financial instruments or terms of the financial instruments may impact margin account requirements. In step 210 a margin account requirement may be recalculated.

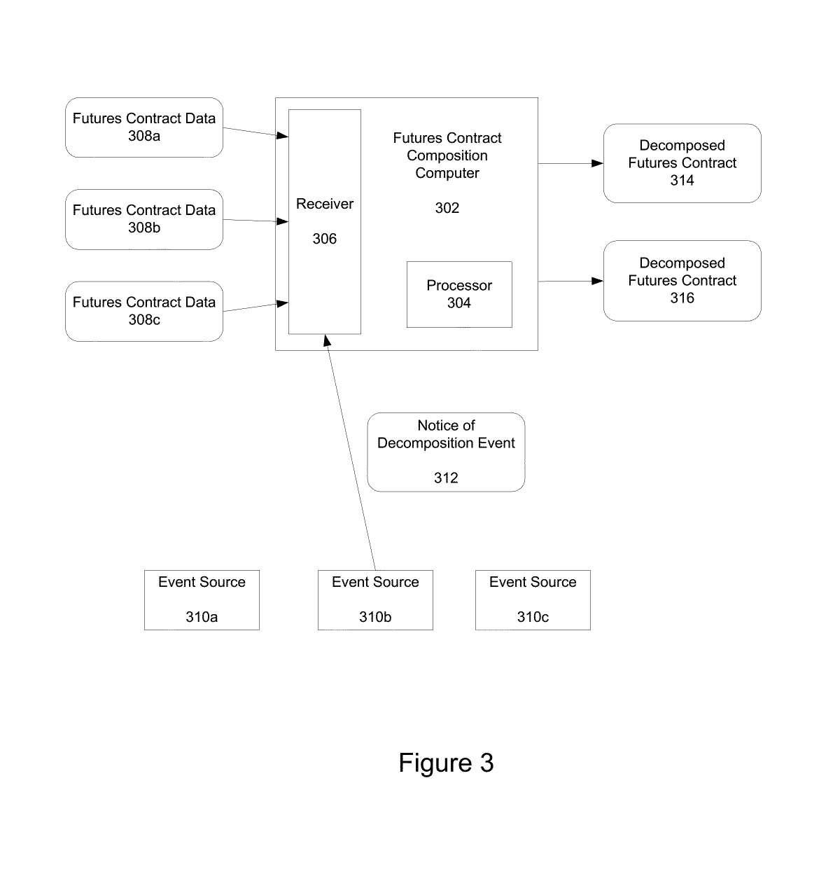

FIG. 3 shows a system that may be used to process futures contracts in accordance with embodiments of the invention. A futures contract composition computer 302 includes a processor 304. Processor 304 may be programmed with computer-executable instructions for processing futures contracts in view of received events. Futures contract composition computer 302 may include a receiver 306 that is configured to receive futures contract data 308a, 308b and 308c. Futures contract data may include the composition and terms of a futures contract. Receiver 306 may also receive event information from event sources 310a, 310b and 310c. In some embodiments one or more event sources may determine when a decomposition event has occurred and will transmit a notice of decomposition event 312 to receiver 306. In other embodiments, processor 304 may be programmed to receive event information and determine when an event is a decomposition event for a futures contract based on one or more of futures contract data 308a, 308b and 308c. When a decomposition event has occurred, futures contract composition computer 302 may decompose an original futures contract into two or more futures contracts, such as futures contracts 314 and 316.

The present invention has been described in terms of preferred and exemplary embodiments thereof. Numerous other embodiments, modifications and variations within the scope and spirit of the invention will occur to persons of ordinary skill in the art from a review of this disclosure.

We claim:

1. A method of
(a) receiving an identification of a first futures contract based on a first collection of financial instruments;
(b) determining by a processor that a decomposition event has occurred; and
(c) after determining that a decomposition event has occurred, dividing by a processor the first futures contract into at least second and third futures contracts.

2. The method of claim 1, wherein the first futures contract is based on a value of an index of credit default swaps.

3. The method of claim 2, wherein at least one of the credit default swaps is based on a commercial entity and the decomposition event comprises a credit event of the commercial entity.

4. The method of claim 3, wherein the credit event comprises the commercial entity defaulting on required payments.

5. The method of claim 3, wherein the credit event comprises a bankruptcy of the commercial entity.

6. The method of claim 1, wherein the futures contract is based on an index of financial instruments.

7. The method of claim 6, wherein the decomposition event comprises a value of one of the financial instruments in the index of financial instruments exceeding a predetermined percentage of a value of the index of financial instruments.

8. The method of claim 1, wherein a settlement date of the second futures contract is different from a settlement date of the third futures contract.

9. The method of claim 8, wherein the settlement date of the third futures contract is the same as a settlement date of the first futures contract.

10. The method of claim 1, wherein the second and third futures contracts are cash settled.

11. The method of claim 1, wherein the first, second and third futures contracts have different notional values.

12. The method of claim 1, further comprising:
(d) after (c) recalculating a margin account requirement.

13. A system comprising:
a receiver that receives futures contract data for a first futures contract based on a first collection of financial instruments and event data; and
a processor coupled to the receiver and programmed with computer-executable instructions to perform the steps of:
(a) identifying the first collection of financial instruments;
(b) determining when a received event corresponds to a decomposition event for one of the financial instruments in the first collection of financial instruments; and
(c) after determining that a decomposition event has been received, dividing the first futures contract into at least second and third futures contracts.

14. The system of claim 13, wherein the first futures contract is based on a value of an index of credit default swaps.

15. The system of claim 14, wherein at least one of the credit default swaps is based on a commercial entity and the decomposition event comprises a credit event of the commercial entity.

16. The system of claim 15, wherein the credit event comprises the commercial entity defaulting on required payments.

17. The system of claim 15, wherein the credit event comprises a bankruptcy of the commercial entity.

18. A tangible non-transitory computer-readable medium containing computer executable instructions that when executed cause a computer device to perform the steps comprising:
(a) receiving an identification of a first futures contract based on a first collection of financial instruments;
(b) determining by a processor that a decomposition event has occurred; and
(c) after determining that a decomposition event has occurred, dividing by a processor the first futures contract into at least second and third futures contracts.

19. The tangible non-transitory computer-readable medium of claim 18, wherein the first futures contract is based on a value of an index of credit default swaps.

20. The tangible non-transitory computer-readable medium of claim 18, further including computer executable instructions that when executed cause a computer device to perform the step comprising:
(d) after (c) recalculating a margin account requirement.
